(19) United States
(12) Patent Application Publication
(10) Pub. No.: US 2009/0202970 A1
(43) Pub. Date: Aug. 13, 2009

(54) Single-Click Support for Curriculum

(76) Inventor: Mythili SRIDHAR, Plano, TX (US)

Correspondence Address: HAYNES AND BOONE, LLP;IP Section, 2323 Victory Avenue, Suite 700, Dallas, TX, 75219, US

(21) Appl. No.: 12/366,826

(22) Filed: Feb. 6, 2009

Related U.S. Application Data
(60) Provisional application No. 61/026,911, filed on Feb. 7, 2008.

(51) Int. Cl. G09B 5/00; G09B 5/02; G09B 7/00

(52) U.S. Cl. 434/350; 434/307 R; 434/362

(57) ABSTRACT

At the click of a button, a student is connected with a live expert or teacher along with the resource the student is viewing. The student and the expert both have the same learning resource in a shared environment and the expert is able to help the student. After the live learning session, the student returns back to self-learning mode and continues with the original sequence.

This application claims the priority under 35 U.S.C. §119 of provisional application No. 61/026,911 filed Feb. 7, 2008, the disclosure of which is hereby incorporated herein by reference.

### BACKGROUND

Students of e-learning face much frustration when they come across a topic they are not able to understand. The e-learning system may provide animations, audio and video support to explain a concept. In spite of these different features, the student may still be stuck, unable to follow a topic or concept and is ready to give up on further learning. The invention described here provides a feature for instant human support at the click of a button on the e-learning system.

### BRIEF DESCRIPTION OF THE DRAWINGS

A better understanding of the present invention will be realized from the detailed description that follows, taken in conjunction with the accompanying drawings, in which:

FIG. 1 is an exemplary E-learning system.

FIGS. 2-20 are exemplary illustrations of display screen images in accordance with one or more aspects of the present disclosure.

FIG. 21 is an E-learning system according to an exemplary aspect of the present disclosure.

FIG. 22 is a flow chart showing exemplary steps for implementing one aspect of the present disclosure.

FIG. 23 is a block diagram showing an E-learning system interfacing with a server according to one exemplary aspect of the present disclosure.

### DETAILED DESCRIPTION

At the click of a button, the student is connected with a live expert or teacher along with the resource (be it an animation or a page or a video or audio) the student is viewing (or reading). The student and the expert both have the same learning resource in a shared environment and the expert is able to help the student. After the live learning session, the student returns back to self-learning mode and continues with the original sequence.

The invention described here offers live human support at the point of failure (during self directed e-learning) and helps a student continue further in the e-learning program. The state of the e-learning system (choices made by a student during self-learning) is also maintained during the switch from self-learning to shared learning with a human subject matter expert. Upon completion of the help session, the student is returned to the original spot in the self-learning program.

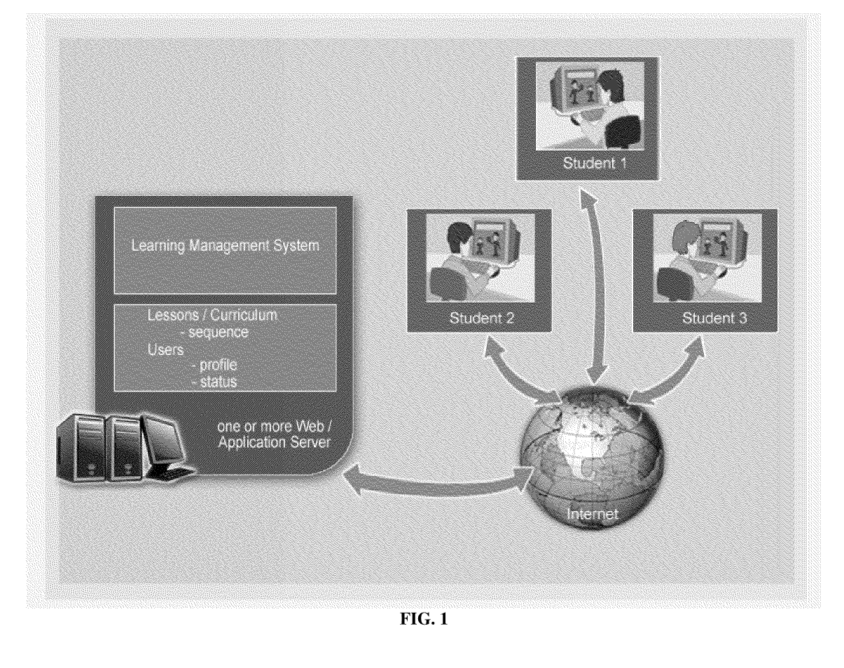

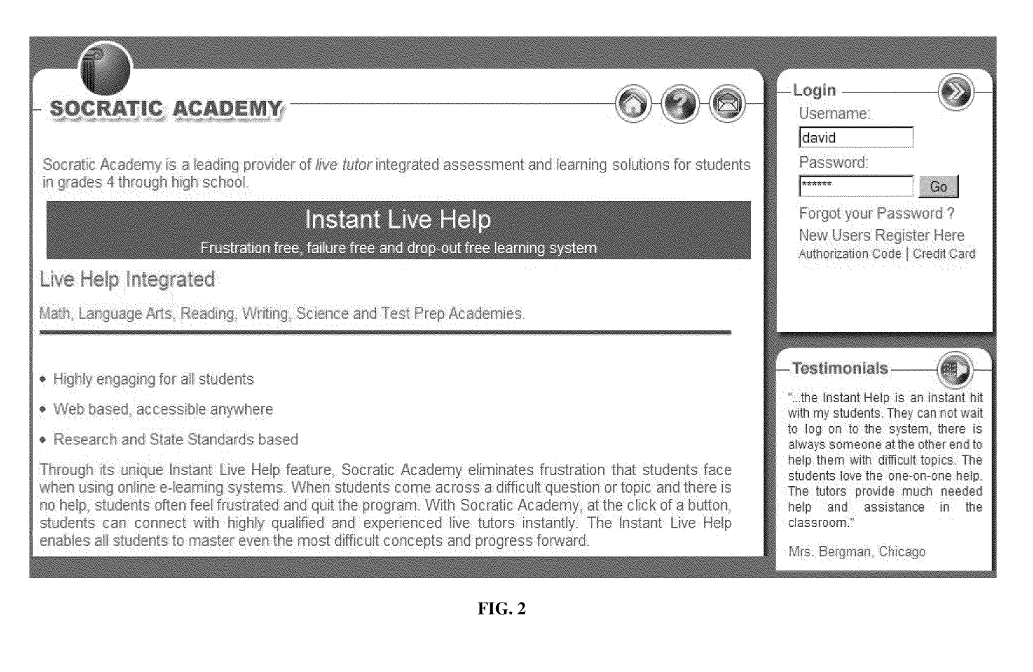

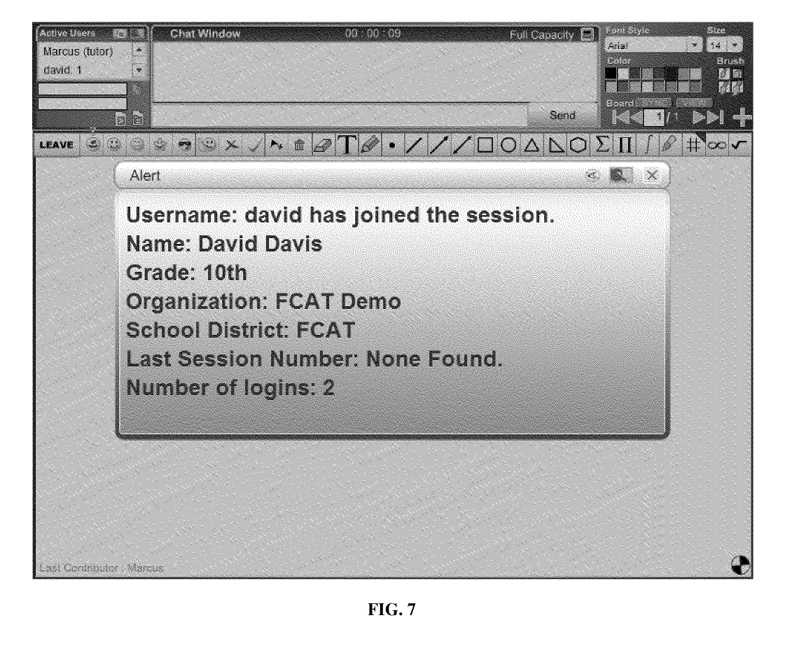

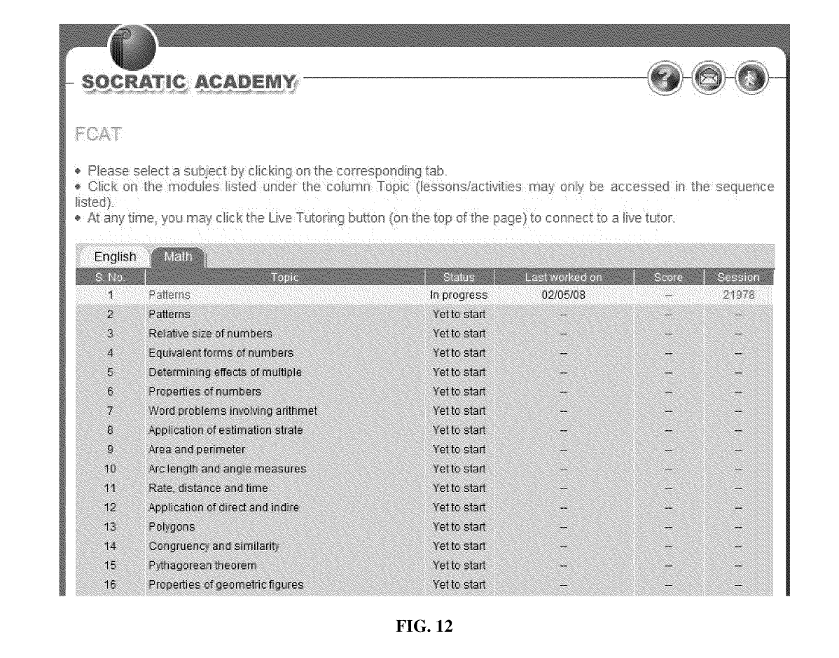

FIG. 1 illustrates the state of the art, self-directed e-learning systems. FIGS. 2 through 6 describe typical self-directed learning in current e-learning systems. FIGS. 7 through 11 demonstrate the one click instant access to a human expert for additional help via a shared learning framework. FIG. 12 illustrates the archives of such help sessions.

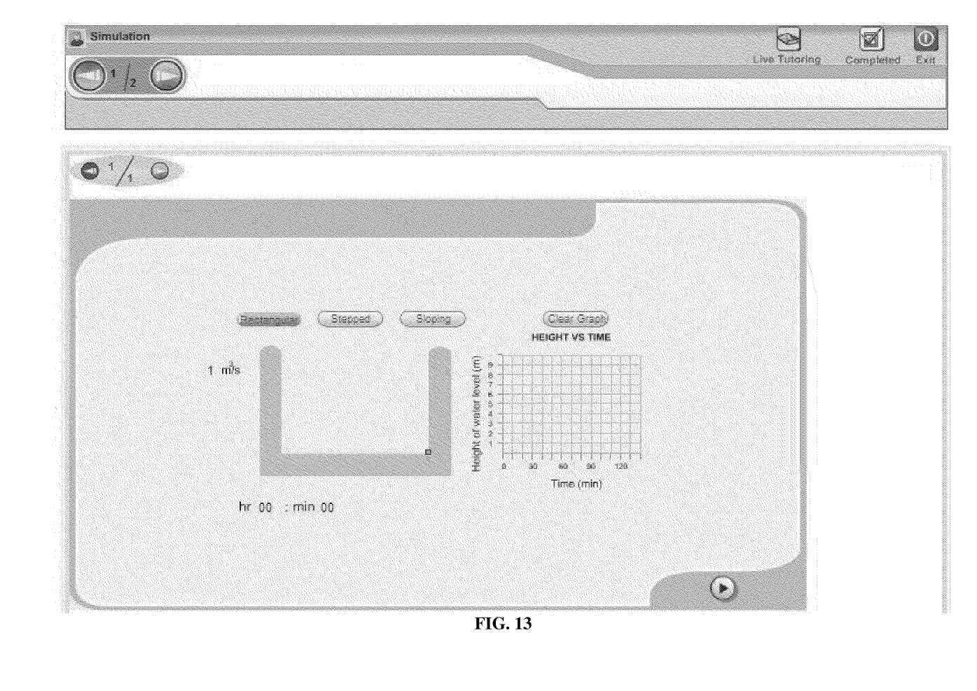

FIGS. 13 through 15 illustrate how state information (choices made by a student) during self-learning mode are preserved and used in the shared learning mode with an expert human teacher.

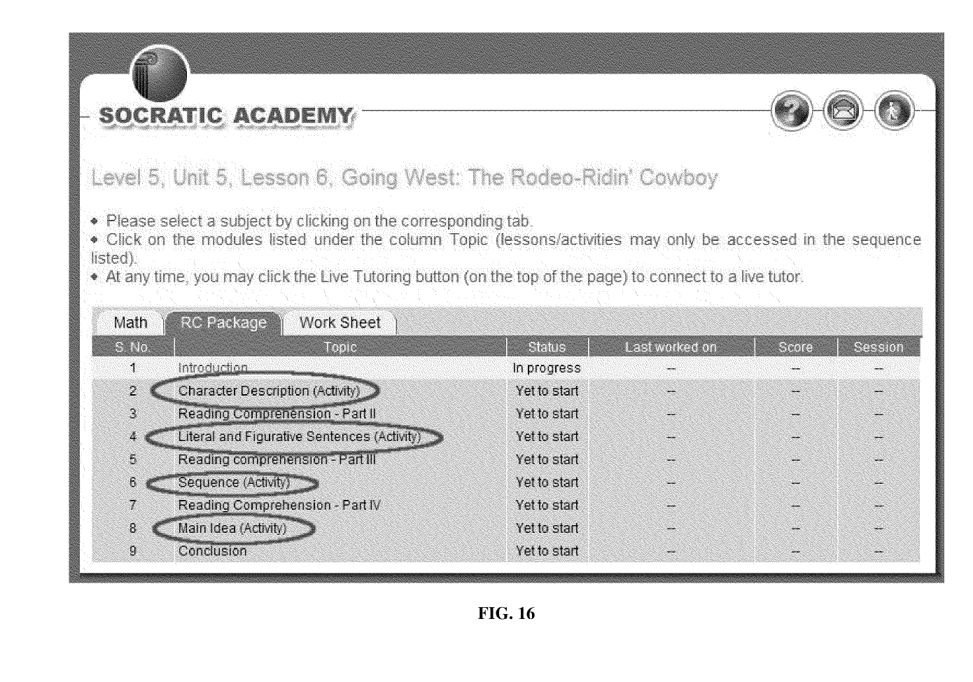

FIGS. 16 through 20 illustrate the invention with examples from a typical introductory level course in Reading comprehension. These figures use both text and activity based learning examples.

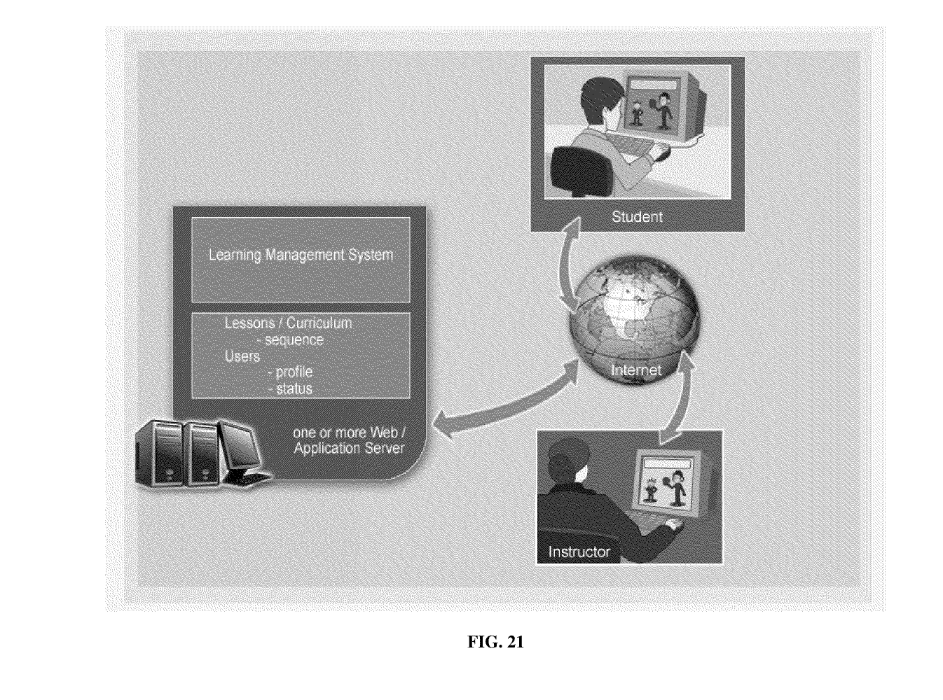

FIG. 21, similar in nature to FIG. 1 illustrates the key features of the invention.

FIG. 1—Current state of the art E-learning systems. Users consume “lessons” (audio, video, animation, text and other resources) in some sequential manner. The flow of lessons may incorporate quizzes and assessment to adjust the sequence of topics/lessons.

FIG. 2—Illustrates a student logging into an e-learning system. Top right box shows the login fields.

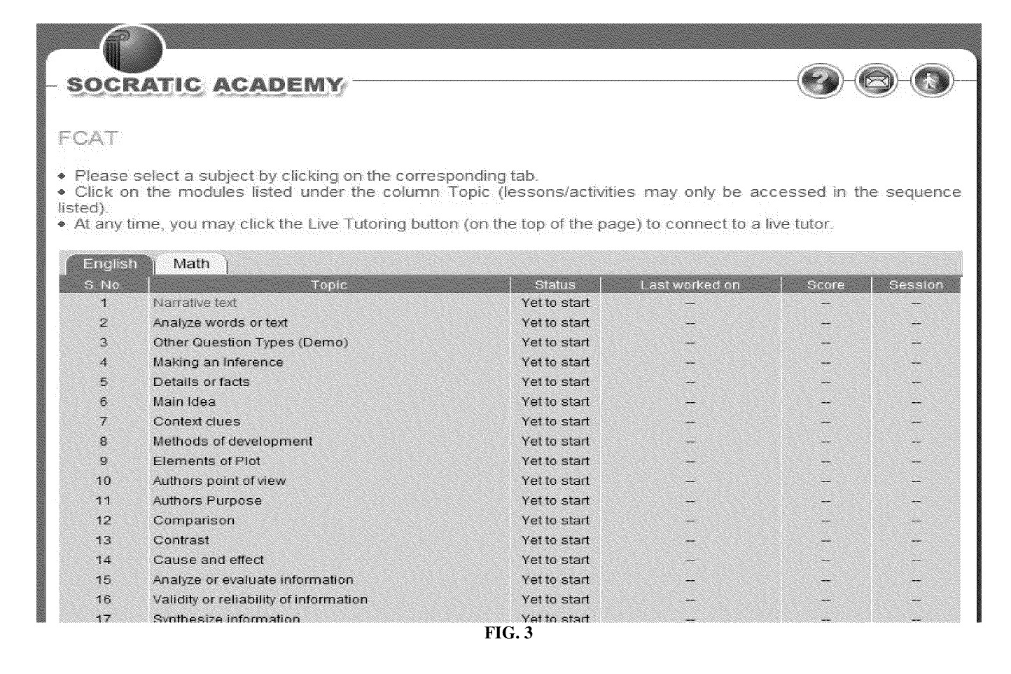

FIG. 3—The list of topics (which may be adjusted based on assessment results) for a subject (in this case English) are shown. Students typically follow such a sequence in all e-learning systems.

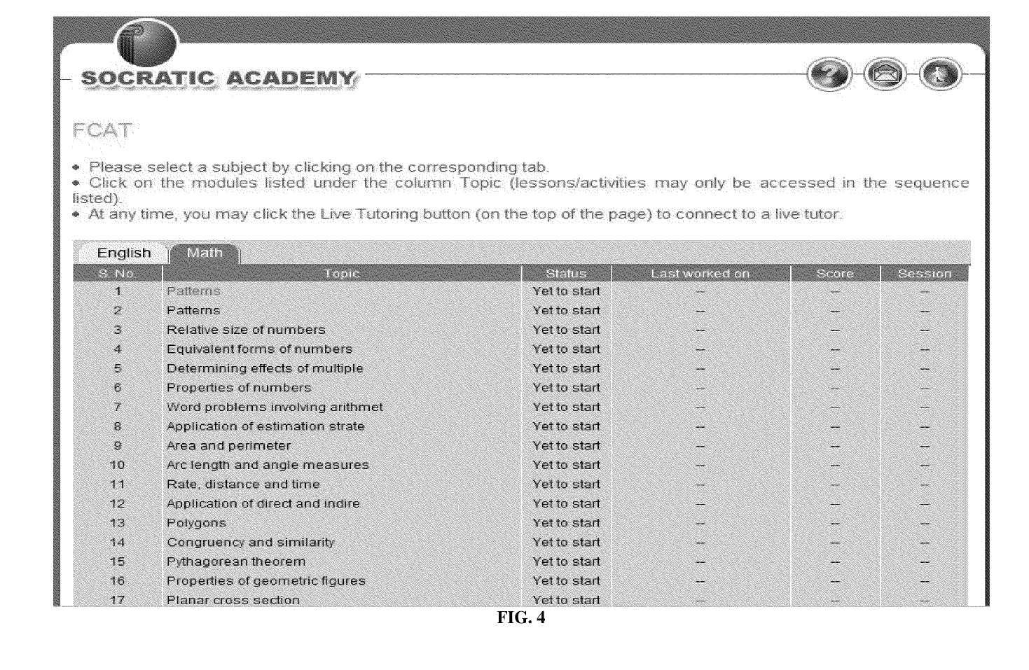

FIG. 4—List of topics for Math are shown. This list is representative of the scope and sequence followed in current state of the art e-learning systems. The learning sessions may involve interacting with animations, text, quiz/practice problems or viewing video files or listening to audio files.

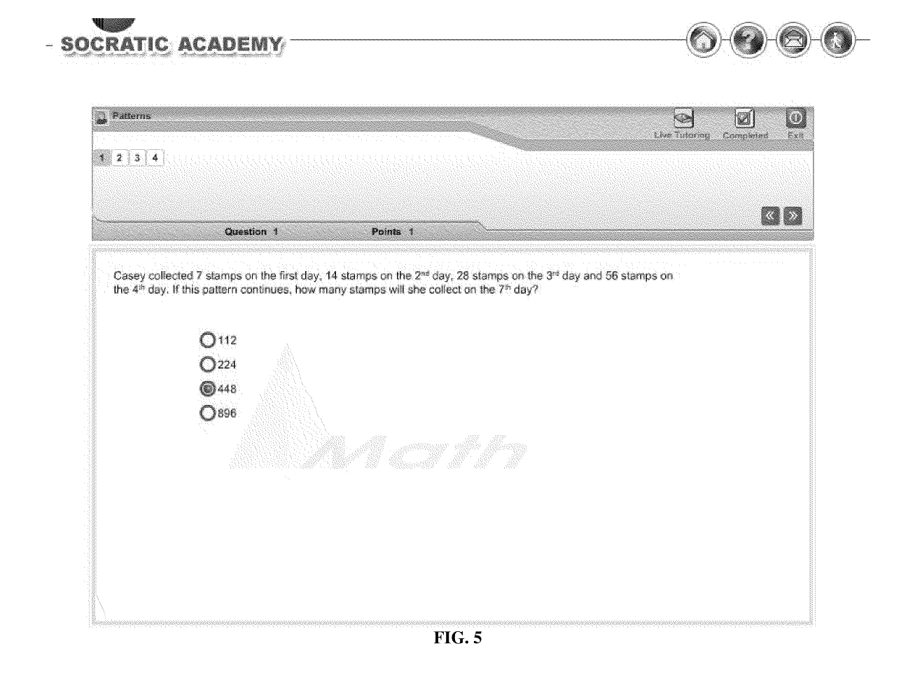

FIG. 5—Shows the flow of learning for a given topic. In this figure, student going though a problem (or assessment) is illustrated. On the top left, one can see numbers 1 through 4 signifying that there are 4 problems in this exercise and that the learner is on the first problem.

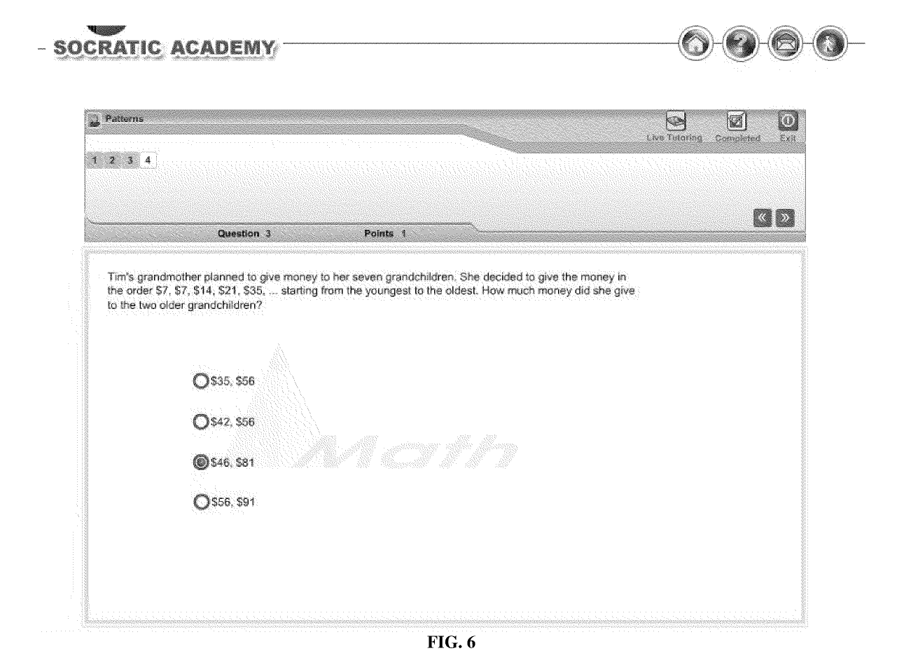

FIG. 6—Student is at exercise 3 in a particular lesson module. Student is assumed to be unable to proceed further in the exercise and needs additional help. Current e-learning systems may provide access to video/audio resources to help the student. In the invention described here, the student clicks the “Live Tutoring” button on the top right. (First in a series of 3 buttons on the top right).

FIG. 7—Students clicking of “live tutoring” button (shown in FIG. 6) connects a student with a live subject matter expert/teacher/tutor. The figure above shows a student connecting with a teacher. David is the name of this particular student.

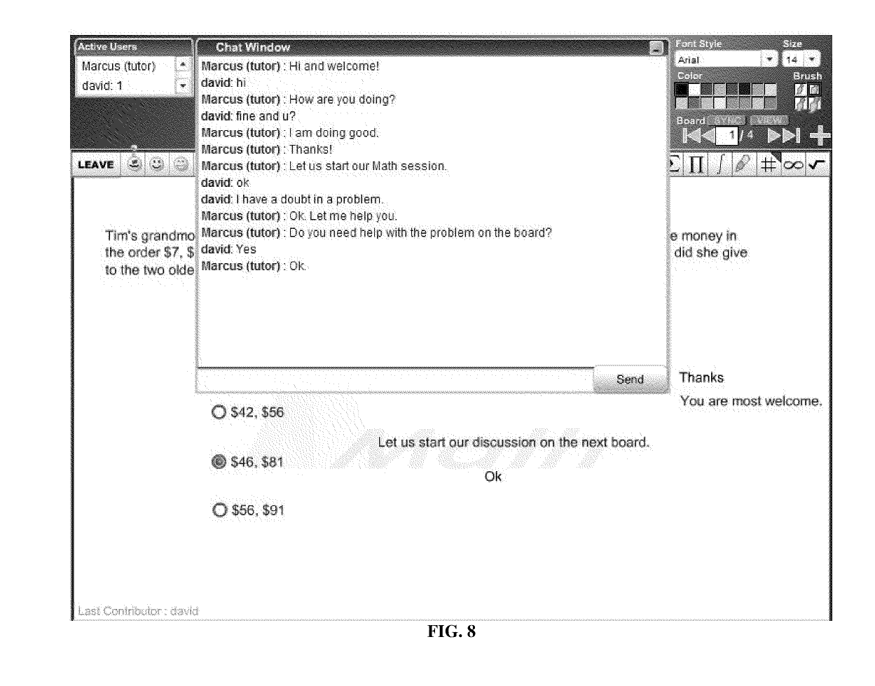

FIG. 8—The “learning resource” the student was working on in the “self-learning” mode is now shared between the tutor and student. In this shared learning space, student and tutor can discuss the lesson topic or resource. The chat window shows initial interaction between the tutor and student. The learning resource the student was working on in the self-learning mode is on the whiteboard underneath the chat window.

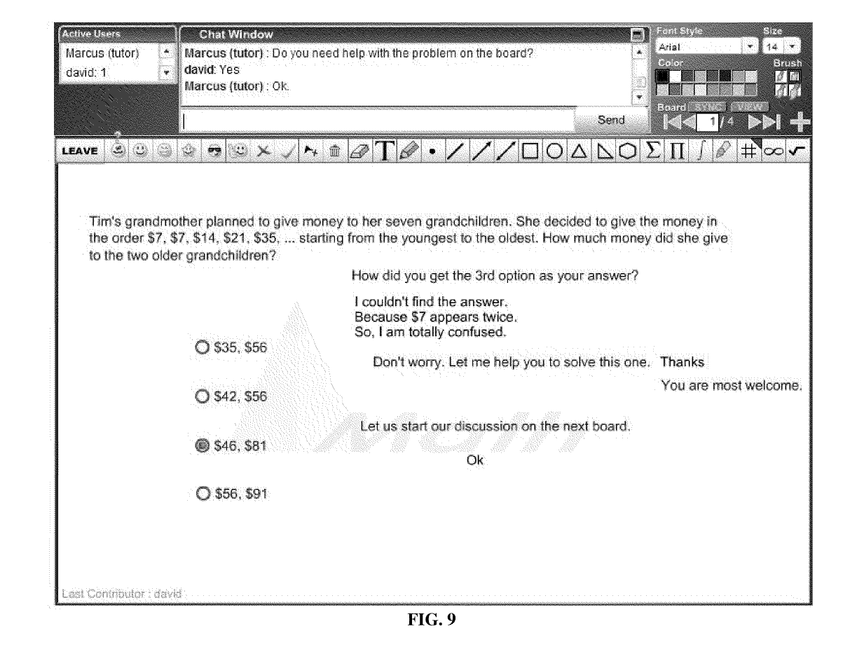

FIG. 9—Further discussion of the topic between tutor/student. Both are able to write (or manipulate) further on the learning resource. Whatever choice the student had made (clicking on the third button) in the self-learning mode is saved and is also used in the shared learning space between the student and the subject matter expert. Through this, the stand-alone learning resource form a self-learning mode becomes a “shared resource” between a learner and the expert (at the click of a button). Now both are able to annotate or “discuss” the topic further.

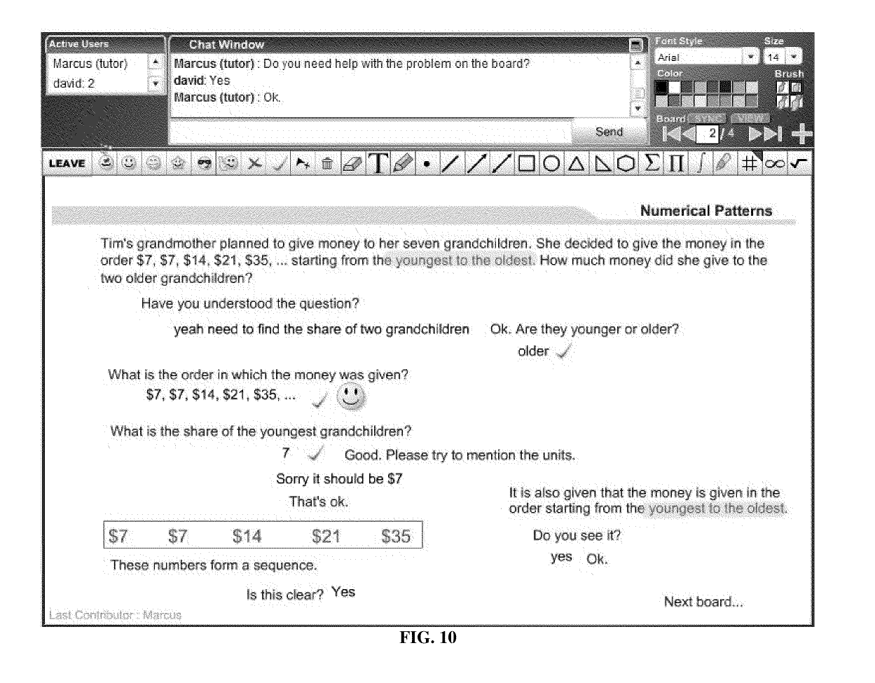

FIG. 10—Further discussion of the topic between the student and the subject matter expert.

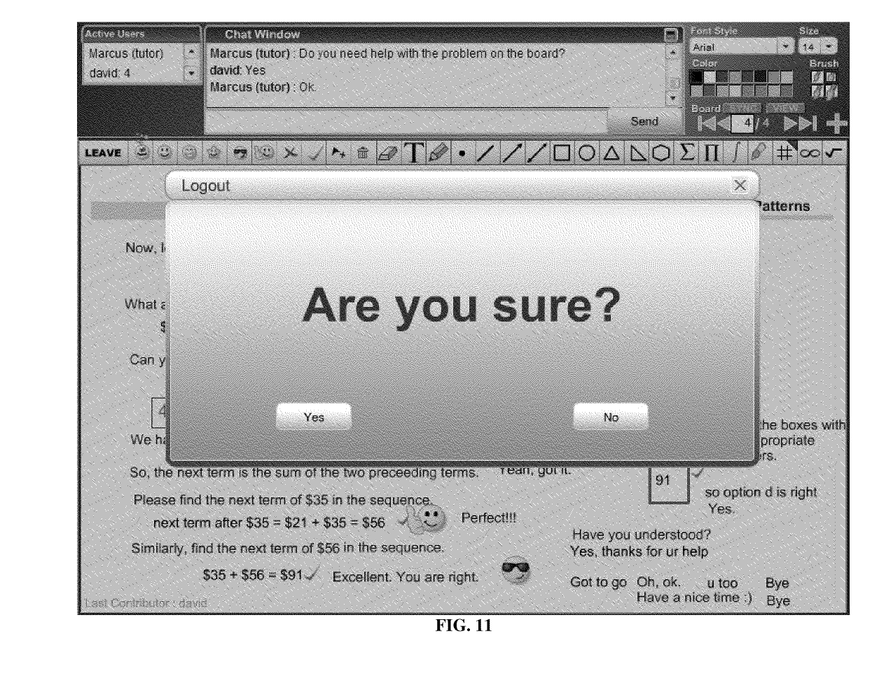

FIG. 11—after the discussion, the student is able to “terminate” the shared session with an expert by clicking the “leave” button (left menu item) and return to self-learning mode. The student is returned to the spot where the student was in the scope and sequence of the course/curriculum.

FIG. 12—The live and shared learning session with an expert becomes a part of the list of topics associated with a subject. The student may later access such archived sessions for further review. In the archived mode, the student can review the interactions with the expert, but is not connected to the expert.

FIG. 13—A simulation based learning resource is shown as part of a curriculum sequence. Student may manipulate and experiment with the interactive controls and set different parameters for the simulation.

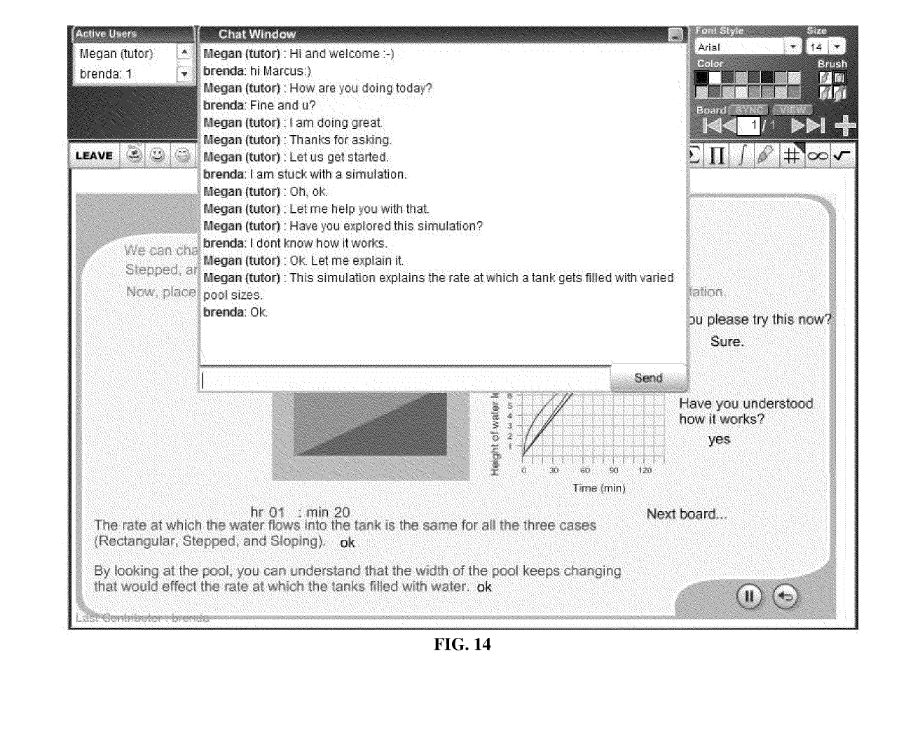

FIG. 14—At the click of the live support button, student gets connected to the tutor (subject matter expert). The state of the simulation, i.e., inputs set by the student are preserved and the such inputs are part of the shared learning with the tutor. The interactions between the student and the learning module/quiz are saved and the used during shared learning mode.

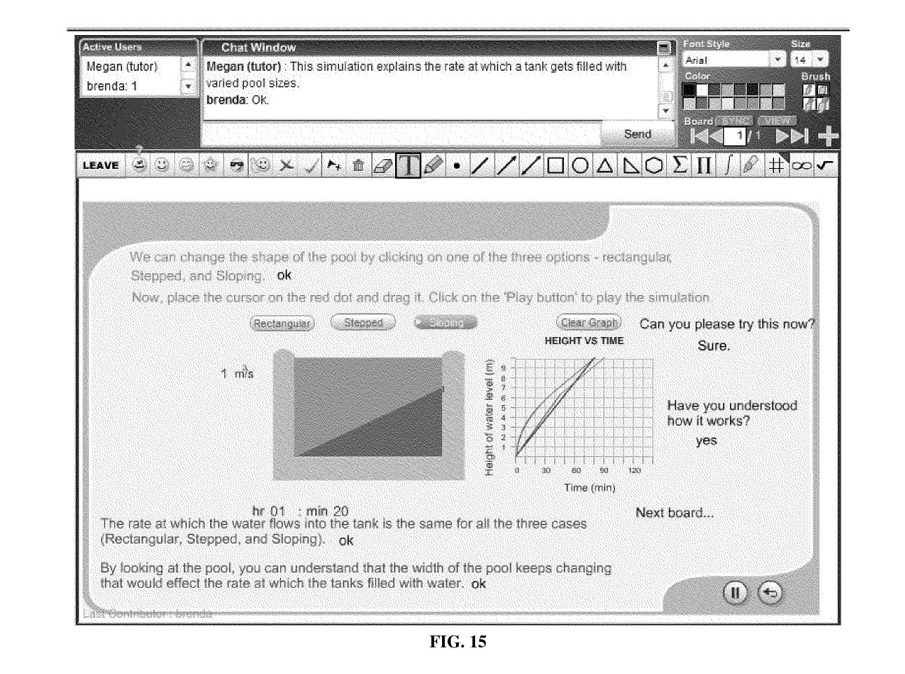

FIG. 15—Shared manipulation of the learning resources by student and the tutor during the live help sessions.

FIG. 16—A typical reading comprehension related curriculum is shown. It consists of hands-on interactive learning activities and comprehension quizzes. In the self-learning mode, a student can go through text (and answer questions associated with the text) and also work on the activities.

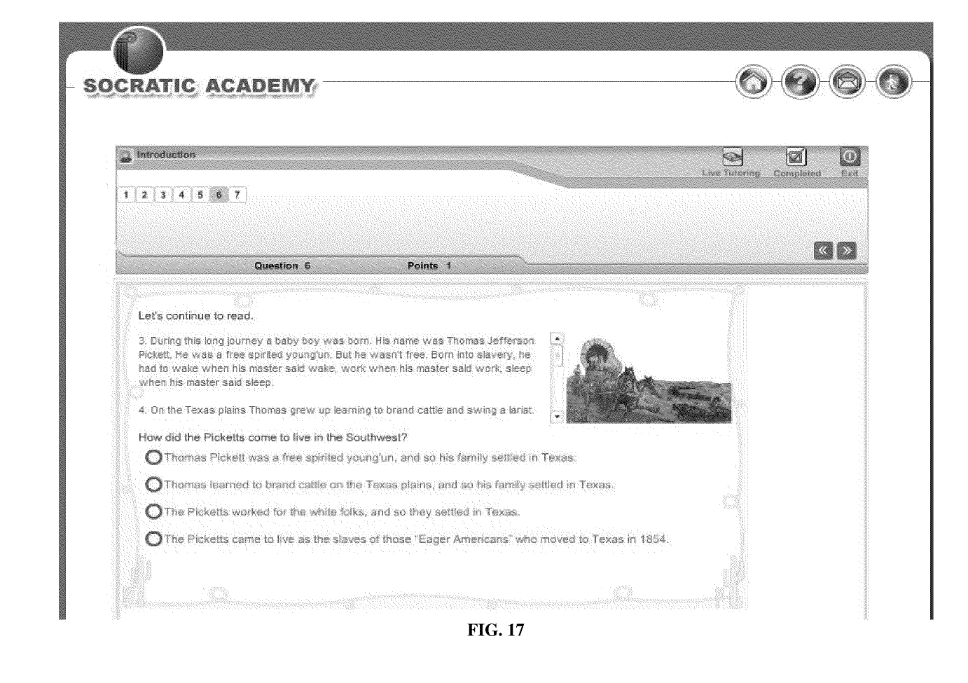

FIG. 17—Normal progression in self-learning mode. Student is in question six on a reading comprehension exercise.

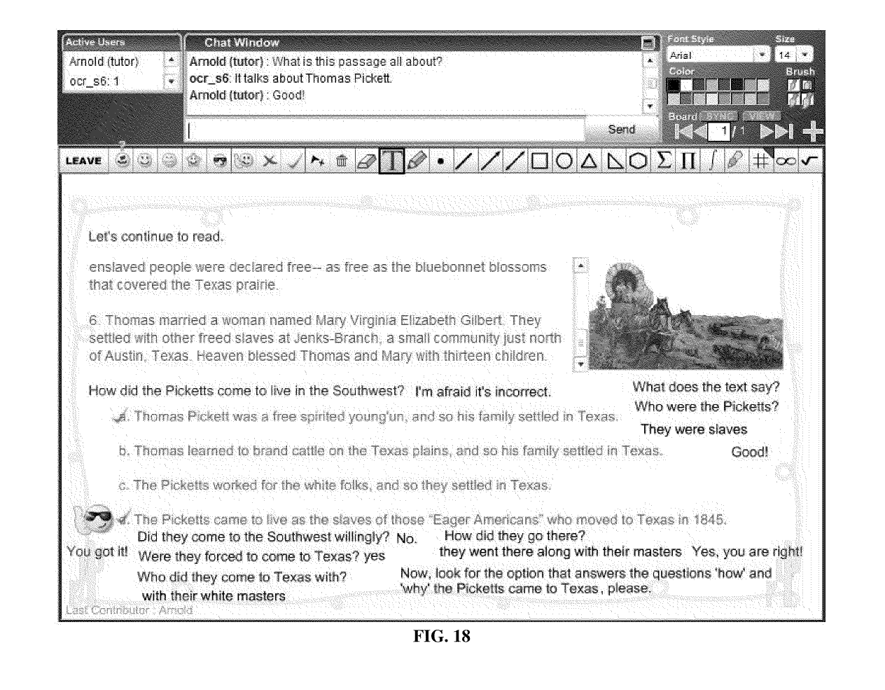

FIG. 18—Upon clicking the button “Live Tutoring”, the lesson the student was working on in self-learning mode (FIG. 16) along with the choices the student may have made are placed in a shared learning space (whiteboard) with a live tutor. The tutor and student interactively discuss the questions further.

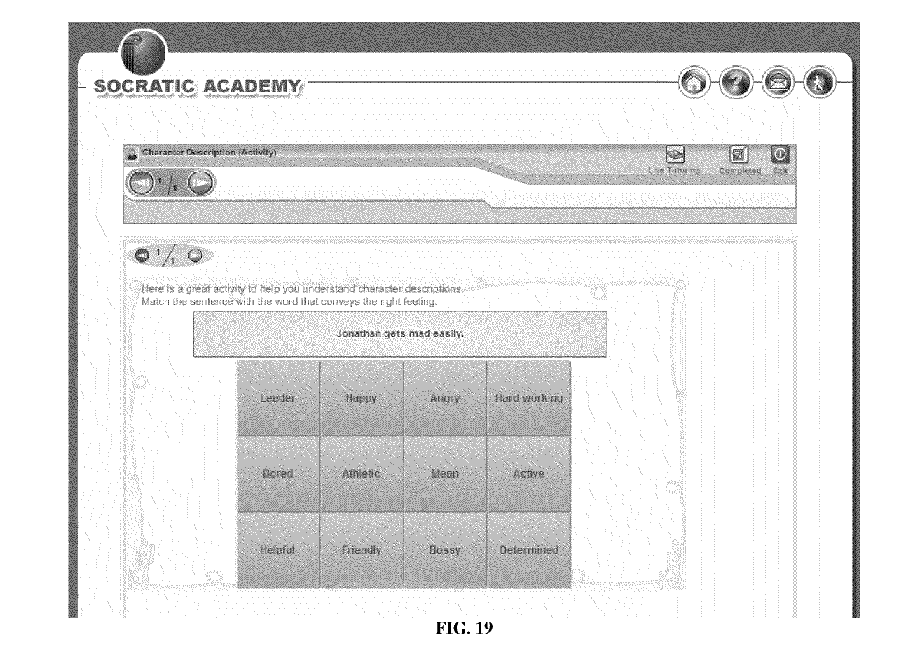

FIG. 19—An interactive learning activity in self-learning mode. Students are supposed to try the activity on their own. They can try different selections associated with the activity. In this example, a student may click on different boxes (words).

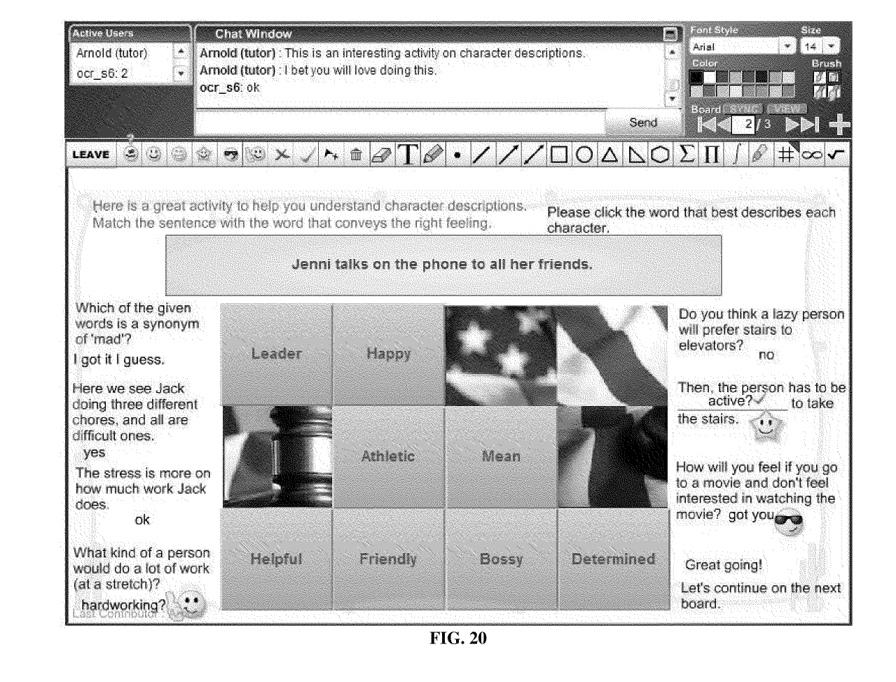

FIG. 20—Upon clicking the “Live Tutoring” button by a student (in self-learning mode), the activity is transferred from self-learning mode to shared learning with an expert tutor. The choices a student had made in the activity are preserved and used in the shared learning space.

FIG. 21—Summary description of the human expert help integrated e-learning system. Student learns in self-learning mode and is able to get help when such help is desired.

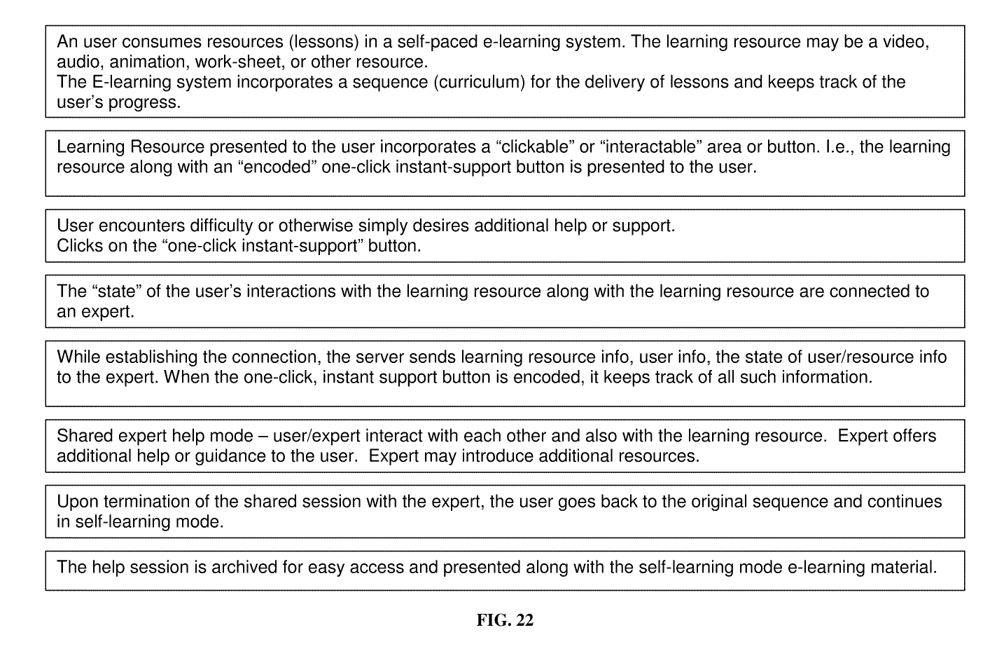

FIG. 22 is an exemplary flow chart showing exemplary steps taken when implementing the subject matter of this disclosure.

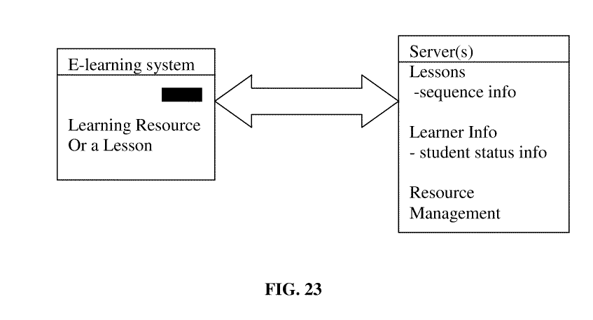

FIG. 23 is a block diagram showing an E-learning system interfacing with a server.

In one exemplary aspect, the present disclosure is directed to an interactive e-learning system. The system includes one or more internet or other network connected computing server systems having a collection of multi-media lessons, quizzes, additional learning resources and a learning management system. The system also includes a student computer station for use by a student desiring e-learning in a specific subject matter. The student computer station communicates with the computing server system through the internet or other computer network. The learning management system generates instruction on the specific subject matter stored within the computer server system for the student. The computer server system and the learning management system are capable of interacting with the student in a two-way conversational mode.

In some aspects, the memory stores information on a learning module for coursework for which the student is going through e-learning. In some aspects, the student computer station communicates via the Internet to communicate with the computing server system. In some aspects, the subject matter is associated with a specific curriculum. The specific curriculum may includes multimedia learning modules and other problems associated with a course load. The problems and an associated step-by-step teaching module solution are stored within the learning management system.

In some aspects, the e-learning system also includes means for communicating with a live subject matter expert. The live subject matter expert may provide instruction on the specified subject matter. The means for communicating with a live subject matter expert may include a whiteboard providing real-time communication of both textual and non-textual contents. The virtual whiteboard may be simultaneously viewable and modifiable by both the student and subject matter expert.

In some aspects, the computing server system includes an interface module for interfacing with the student through the student computer station. In some aspects, the learning management system provides feedback on tasks completed by the student.

In another exemplary aspect, the present disclosure is directed to a method of providing an interactive e-learning session to a student in a specific subject matter. The method may include the steps of initiating contact with a computing system by a student via a student computer station. The computing server system has a learning management system and a memory storing information on the specific subject matter. The method may include the steps of selecting a specific subject matter for which the student needs e-learning, querying by the student on a specific problem or question on the specific subject matter, and responding by the computing server system by generating a teaching module on the specific problem or question on the specific subject matter. The method also may include engaging in a two-way conversation between the computing server system and the student on the specific problem or question on the specific subject matter.

In some aspects, the specific subject matter includes reference materials from a specific course curriculum. The specific course curriculum can include multimedia learning modules, problems and questions, the multimedia learning modules, problems, questions and solutions being managed by the learning management system. The computing system provides e-learning on a specific problem or question queried by the student.

In some aspects, the method also includes the steps of requesting by the student additional support from a live subject matter expert, connecting a live subject matter expert with the student by the computing system, and help by the live subject matter expert to the student.

In some aspects, the student communicates with the live subject matter expert utilizing a whiteboard to communicate both textual and non-textual content.

In some aspects, the learning module or quiz or learning resource the student was working on prior to initiating the communication with the subject matter expert is automatically placed on the shared learning space or whiteboard between the student and the subject matter expert.

In some aspects, the status of the learning module or quiz or learning resource the student was working on prior to initiating the communication with the subject matter expert are captured and the status information of the learning module, or quiz or learning resource is automatically placed on the shared whiteboard between the student and the subject matter expert.

In some aspects, the e-learning system includes means for archiving a session and any associated data conducted between the student, the subject matter expert and the computing server system.

In some aspects, the interactive e-learning system further comprises means for taking the student back to the original module in the curriculum and in self e-learning mode upon completion of the help session with a subject matter expert.

Although a selected embodiment has been illustrated and described, it should be understood that a variety of substitutions and alterations are possible without departing from the spirit and scope of the present invention, as defined by the claims that follow.

I claim:

1. An interactive e-learning system, the system comprising: one or more internet connected computing server systems having a collection of multi-media lessons, quizzes, additional learning resources and a learning management system; and a student computer station for use by a student desiring e-learning in a specific subject matter, the student computer station communicating with the computing server system through the internet or other computer network; the learning management system generating instruction on the specific subject matter stored within the computer server system for the student, the computer server system and the learning management system capable of interacting with the student in a two-way conversational mode.

2. The interactive e-learning system of claim 1 wherein the memory stores information on a learning module for coursework for which the student is going through e-learning.

3. The interactive e-learning system of claim 1 wherein the student computer station communicates via the Internet to communicate with the computing server system.

4. The interactive e-learning system of claim 1 wherein the subject matter is associated with a specific curriculum.

5. The interactive e-learning system of claim 4 wherein the specific curriculum includes multimedia learning modules and other problems associated with a course load, the problems and an associated step-by-step teaching module solution being stored within the learning management system.

6. The interactive e-learning system of claim 1 further comprising: means for communicating with a live subject matter expert, the live subject matter expert providing instruction on the specified subject matter.

7. The interactive tutorial system of claim 6 wherein the means for communicating with a live subject matter expert includes a whiteboard providing real-time communication of both textual and non-textual contents.

8. The interactive e-learning system of claim 1 wherein the computing server system includes an interface module for interfacing with the student through the student computer station.

9. The interactive tutorial system of claim 1 wherein the learning management system provides feedback on tasks completed by the student.

10. A method of providing an interactive e-learning session to a student in a specific subject matter, the method comprising the steps of: initiating contact with a computing system by a student via a student computer station, the computing server system having learning management system and a memory storing information on the specific subject matter; selecting a specific subject matter for which the student needs e-learning; querying by the student on a specific problem or question on the specific subject matter; responding by the computing server system by generating a teaching module on the specific problem or question on the specific subject matter; and engaging in a two-way conversation between the computing server system and the student on the specific problem or question on the specific subject matter.

11. The method of providing an interactive e-learning session to a student in a specific subject matter of claim 10 wherein the specific subject matter includes reference materials from a specific course curriculum.

12. The method of providing an interactive e-learning session to a student in a specific subject matter of claim 11 wherein: the specific course curriculum includes multimedia learning modules, problems and questions, the multimedia learning modules, problems, questions and solutions being managed by the learning management system; and the computing system providing e-learning on a specific problem or question queried by the student.

13. The method of providing an interactive e-learning session to a student in a specific subject matter of claim 10 further comprising the steps of: requesting by the student additional support from a live subject matter expert; connecting a live subject matter expert with the student by the computing system; and help by the live subject matter expert to the student.

14. The method of providing an interactive e-learning session to a student in a specific subject matter of claim 13 wherein the student communicates with the live subject matter expert utilizing a whiteboard to communicate both textual and non-textual contents.

15. The method of providing an interactive e-learning session to a student in a specific subject matter of claim 13 wherein the learning module or quiz or learning resource the student was working on prior to initiating the communication with the subject matter expert is automatically placed on the shared learning space or whiteboard between the student and the subject matter expert.

16. The method of providing an interactive e-learning session to a student in a specific subject matter of claim 13 wherein the status of the learning module or quiz or learning resource the student was working on prior to initiating the communication with the subject matter expert are captured and the status information of the learning module, or quiz or learning resource is automatically placed on the shared whiteboard between the student and the subject matter expert.

17. The interactive e-learning system of claim 13 further comprising means for archiving a session and any associated data conducted between the student, the subject matter expert and the computing server system.

18. The interactive e-learning system of claim 13 further comprising means for taking the student back to the original module in the curriculum and in self e-learning mode upon completion of the help session with a subject matter expert.
